(19) United States
(12) Patent Application Publication
(10) Pub. No.: US 2018/0191159 A1
(43) Pub. Date: Jul. 5, 2018

(54) Auxiliary Signaling in Light Switch Traveler Line

(71) Applicants: David Moody, Morrisville, NC (US); David Webster, Morrisville, NC (US)

(72) Inventors: David Moody, Morrisville, NC (US); David Webster, Morrisville, NC (US)

(21) Appl. No.: 15/398,504

(22) Filed: Jan. 4, 2017

(51) Int. Cl. H02J 3/14

(52) U.S. Cl. CPC H02J 3/14; H05B 37/0209

(57) ABSTRACT

This document presents a system and method for presenting the invention in 150 words or less.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Automation provides many opportunities to create system level actions and functions that are activated by a user to better control their environment. Such systems are installed in homes and other buildings to permit one or more users to customize the environment for their liking or for functions, moods, or experiences that may take place in the space into which the automation system has been installed. Master controllers may also provide the users of a building or home space to control functions from within the space, or outside of the space through the use of networking and wireless technology.

Numerous functions being activated can overwhelm existing home and office wiring and make it difficult to install new functions into existing spaces economically and efficiently. Optimizing the existing infrastructure can create opportunities to save time and space by not having to remove existing wiring and other infrastructure to install new functionality.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a switch connected into a circuit having a traveler line connection consistent with certain embodiments of the present invention.

FIG. 2 is a view of the timing pulse generated with button activations on the switch consistent with certain embodiments of the present invention.

FIG. 3 is a flow diagram for operation of switches utilizing the traveler signaling line consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Providing a solution to permit a dimmer switch to be compatible with 3-way switching presents a challenge in that in current configurations a physical 3-way switch would have to be installed at every position involved in the 3-way switching circuit. This solution is relatively expensive. Designing a less expensive switch, or providing a switching method at each switching position would be a preferred solution to this issue.

Existing methods of wiring 3-way and 4-way switches in houses involve using a 4^{th} conductor to facilitate the load switching. This method of wiring means that all switches must pass the current for the load. In order to take advantage of the features of having an available 4^{th} wire, it was decided to use the 4^{th} wire, which is often referred to as the traveler, as a signaling wire. In this way, the traveler wire does not carry the current for the load, but may be used to carry voltage at a very low current rating only when the traveler wire is engaged.

In an embodiment, when the button on an Auxiliary switch is pressed, the traveler wire in engaged and turns on the 120 V at a very low current rating on the traveler wire. The use of the traveler wire as a signaling and engagement solution allows multiple switches to be installed with all the Auxiliary switch outputs tied together with the traveler wire. This solution also takes advantage of the existing wiring in houses to realize this solution as the auxiliary wire may be attached to the auxiliary switch wire associated with each installed switch.

In an embodiment, each auxiliary switch is configured as a single button. The Master switch then treats the auxiliary switch input as just another button that may be used to initiate a function. The system may be configured such that line and neutral wires are connected in parallel to the master switch, which controls the dimming function. The duration of the auxiliary button “ON” time is monitored, where the button “ON” time is the amount of time the voltage level is high. This permits the dimming of the load to be effected from one or more auxiliary switches.

Future embodiments may incorporate additional signaling to allow multiple buttons to be configured at each Aux Switch. Additional signaling may indicate the specific button pressed on the switch via varied pulse widths. In a non-limiting example, multiple button configurations permits a possible signaling design to indicate the specific button pressed. Each button is configured with a different amount of “ON” time. In this non-limiting example, button one may have an “ON” time of x, where button two may have an “ON” time of 2x, button three may have an “ON” time of 3x, and button four may have an “ON” time of 4x. The different values for “ON” time assigned to each button permits the master controller and the master switch to identify the button that has been depressed and permits the dimming of the load to be controlled from one or more auxiliary switches. Input processing on the Master Switch associated with the Master controller would detect these varied pulse widths and activate a change in other system elements.

In an embodiment, the duration of the “ON” time that is sent when an auxiliary switch is pressed may be assigned by the master controller to the activation of one or more elements of a home network. The “ON” time duration may be pre-configured to be used as a dimming signal and perform the dimming of a light element. In an alternative embodiment, a particular “ON” time duration may be pre-configured as the signal to initiate a mood or experience within a physical space by activating certain light, sound, and other physical devices within a particular physical space. Multiple “ON” time duration values may be assigned to a plurality of devices, commands, and/or elements within a home space. The varied pulse widths may thus be configured as messaging commands for the Master controller, permitting one switch or multiple switches to control lighting, audio, thermostat, appliance, security systems, and other elements of a network connected home without changing existing wiring in the network connected home.

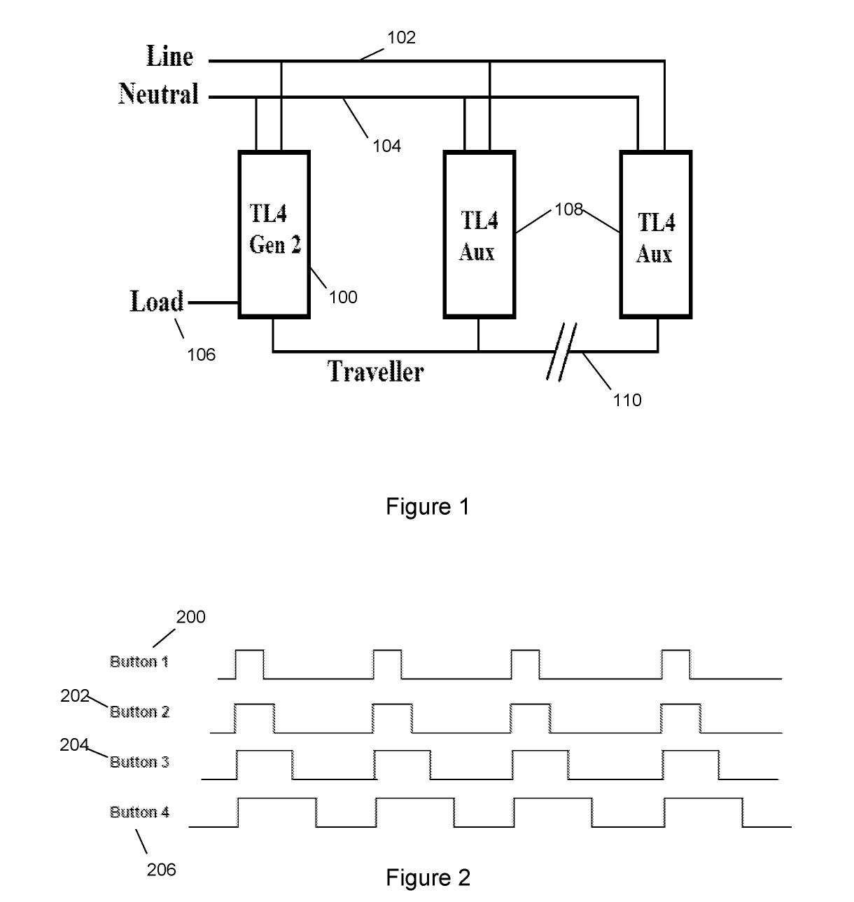

Turning now to FIG. 1, this figure presents a view of a switch connected into a circuit having a traveler line connection consistent with certain embodiments of the present invention. In an exemplary embodiment, a Master switch 100 is physically connected to incoming line 102 and neutral 104 electrical connections. The Master switch 100 is also connected to a load 106 that may activate a function, such as, in a non-limiting example, a dimming function that is applied to a lighting element (not shown) electrically connected to the circuit. The Master switch 100 may also be connected to one or more auxiliary switches 108 that are connected to the line 102 and neutral 104 electrical connections as well as to a traveler line 110 electrical connection. The traveler line 100 is connected to each auxiliary switch 108 such that only by depressing the auxiliary switch 108 is there a current flowing through the traveler line 110. When the Master switch 100 detects the current flowing on the traveler line 110, the Master switch 100 analyzes the timing of the current flow to determine which auxiliary switch 108 from a pre-configured group of auxiliary switches 108 has been depressed. The Master switch 100 may then activate the function for which the auxiliary switch 108 was depressed.

In a non-limiting example, multiple auxiliary switches 108 may be electrically connected to the traveler line 110 where each auxiliary switch 108 is expected to activate the same function. In this non-limiting example, a dimming function may be enabled by depressing any auxiliary switch 108 activation. In an alternative exemplary embodiment, the Master switch 100 may determine which auxiliary switch 108 has been depressed and a different function may be pre-configured to be activated by different auxiliary switch 108 activations.

Turning now to FIG. 2, this figure presents a view of the timing pulse generated with button activations on the switch consistent with certain embodiments of the present invention. In an exemplary embodiment, the system presents timing of current transitions on the traveler line (not shown) when particular buttons, each button of which may be associated with a particular auxiliary switch or multiple buttons may be associated with a single auxiliary switch. In this exemplary embodiment, a first button 200, designated as Button 1, may be associated with a single auxiliary switch, or the first button 200 may be associated with a first button position on an auxiliary switch having multiple button positions designated as active for the auxiliary switch. In this exemplary embodiment, when a user presses on the first button 200, the auxiliary switch will generate a low level current having a particular timing for the transition to a higher current level, and the time at which the current remains at the higher level, the cycle timing from zero current to current high and from current high to zero current, being associated with a particular button and auxiliary switch. The Master switch may analyze the incoming current transition timing as being assigned to the first button 200. The Master switch may then determine, using a pre-configured system configuration, a particular function that should be activated when the electrical current transition and timing associated with the first button 200 is transmitted on the traveler line and received at the Master switch.

In an exemplary embodiment, additional buttons (202, 204, 206) associated with an auxiliary switch may be electrically connected to the Master switch. Each additional button (202, 204, 206), when pressed, may have a different cycle time during which an electrical signal is generated on the traveler line. In a non-limiting example, when button two (202) is pressed, the current transition from zero current to high current may be preconfigured to have a cycle time different from button one (200). The different cycle time permits the Master switch to identify the activation signal on the Traveler line as originating from button two 202. Upon determining the button from which the activation signal has originated, the Master switch may activate a function, feature, or other action that is assigned to button two (202). In additional non-limiting embodiments, button three (204) and button four (206) may be configured with preconfigured cycle times for each button, permitting the Master switch to identify a button press of these buttons as an activation signal for functions, features, or actions assigned to button three (204) or button four (206).

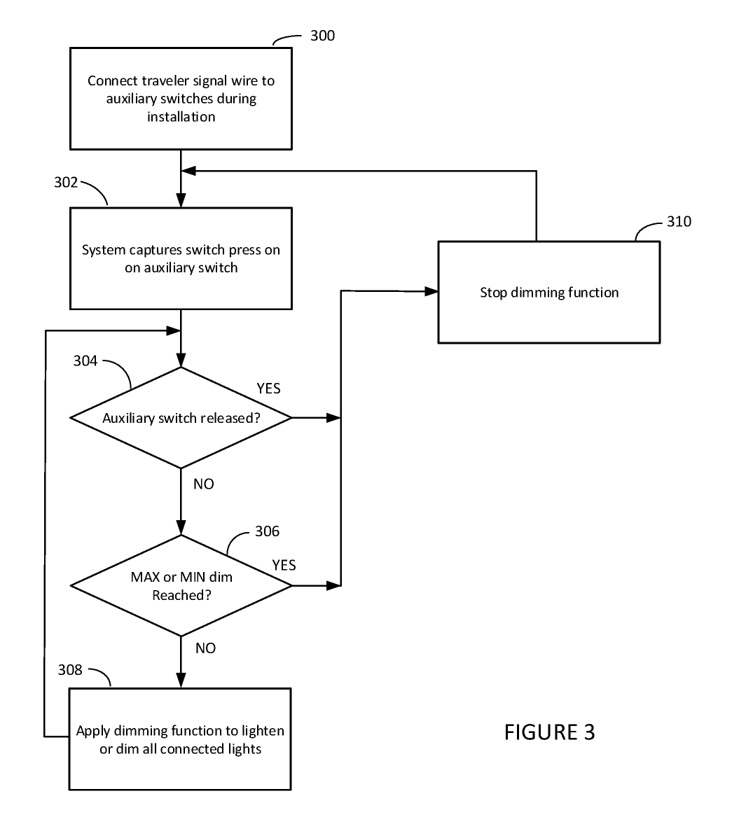

Turning now to FIG. 3, this figure presents an operational flow diagram for the operation of the traveler signaling line consistent with certain embodiments of the present invention. In this embodiment, a Master switch may be installed within a domicile or other building. Auxiliary switches may be installed utilizing existing wiring for 3-way and 4-way switches with a Traveler wire connected from each auxiliary switch to the Master switch during installation 300. When the system is in operation, the system in communication with the Master switch captures a switch press on an auxiliary switch when a current, either steady high or cycling between a zero current state and a current high state, is detected on the Traveler line by the Master switch 302.

At 304 the system, through the Master switch, may check to determine if the button on an auxiliary switch has been released or is no longer being depressed. If the button on the auxiliary switch continues to be depressed, the system may check to determine if the function, feature or action has been completed 306. In a non-limiting example, if the function associated with the button of an auxiliary switch is assigned to a dimming function, the system could check to determine if the minimum value or maximum value for the dimming function has been reached. Continuing with this non-limiting example, at 308 if the dimming function maximum or minimum value has not been reached, the system may continue to perform the dimming function, either decreasing the electrical current or increasing the electrical current applied to the light for which the dimming function has been requested.

The system then returns to 304 to once again check for actions by the user requesting the function.

If the system determines that the auxiliary switch has been released or that the maximum or minimum value for the function has been reached, the system at 310 may stop performing the function. In this non-limiting example, the system would stop the dimming function and return to a wait state at 302 to await any further activation of the function.

While certain illustrative embodiments have been described, it is evident that many alternatives, modifications, permutations and variations will become apparent to those skilled in the art in light of the foregoing description.

We claim:

1. A system for electrical switch control of one or more devices or functions, comprising:
a master switch electrically connected to one or more auxiliary switches;
the master switch having an integral processor;
each auxiliary switch having one or more preconfigured portions operative to initiate an electrical transition when any one of the preconfigured portions is depressed by a user;
the electrical transition from the auxiliary switch being received at the master switch;
a software module resident in said processor operative to determine a particular function to be activated when the electrical transition is received from any one of the auxiliary switches;
activating the one or more devices or functions associated with said particular function.

2. The system of claim 1, further comprising a wired electrical connection between the master switch and one or more auxiliary switches that is in addition to the line, neutral and load electrical wire connections.

3. The system of claim 2, where the said electrical wired connection that is in addition to the line, neutral and load connections is a fourth electrical wire connection configured to carry voltage at a very low current rating only when the fourth electrical wire connection is engaged.

4. The system of claim 3, where the electrical connection comprises zero voltage when the fourth electrical wire connection is engaged and a detectable voltage at a very low current rating when the fourth electrical wire connection is engaged.

5. The system of claim 1, further comprising a software module having a set of pre-configured instructions associated with one or more particular functions.

6. The system of claim 5, where the pre-configured instructions are selected based upon the activation of a particular auxiliary switch.

7. The system of claim 1, where the one or more preconfigured portions operative to initiate an electrical transition are configured as buttons on the surface of the auxiliary switch.

8. The system of claim 7, where the buttons on the surface of auxiliary switch may be configured as one, two, or four buttons on any auxiliary switch.

9. The system of claim 1, where the electrical transition is held as a voltage above zero voltage for a configured period of time associated with a button, and where the configured period of time is different for each button associated with an auxiliary switch that is configured to have two or more buttons.

10. The system of claim 9, where the configured period of time may be interpreted by a software module resident in the processor as being associated with a pre-configured control of a device or function.

11. The system of claim 10, where the function comprises a dimming function a brightening function, other light controls, or initiating pre-configured light and audio settings.

12. The system of claim 10, where the device control comprises initiating or turning off lights, audio devices, thermostats, security devices, or any other device requiring electrical connectivity to function.
